(19) United States
(12) Patent Application Publication
(10) Pub. No.: US 2011/0082851 A1
(43) Pub. Date: Apr. 7, 2011

(54) GMPS/TMS search engine and method thereof

(75) Inventor: Xiaohong Hansen, El Monte, CA (US)

(73) Assignee: MWR International Inc.

(21) Appl. No.: 12/806,139

(22) Filed: Aug. 6, 2010

Related U.S. Application Data
(60) Provisional application No. 61/237,571, filed on Aug. 27, 2009.

(51) Int. Cl. G06F 17/30

(52) U.S. Cl. 707/708; 707/E17.108

(57) ABSTRACT

A business exploitation system for communicating with a network terminals, comprising a networking system for enrolling members and information sharing, adapted for assigning a member status to the business entity which requires a contact information with a real business address; a global map position search (GMPS) system for providing a GMPS method; a target map search (TMS) system for providing a TMS method, where a search result obtained through the system includes one or more search result units, assigned with a sub-category associated with a preset category symbol, thereby the search result is displayed as the search result units in the form of geographical spots on a map at a glance, that the contact information and accessory information of the member is associated with the corresponding geographical spot on the map which is viewable through the corresponding geographical spot on the map.

### CROSS REFERENCE OF RELATED APPLICATION

This is a non-provisional application that claims the benefit of priority under 35 U.S.C. §119 to a non-provisional application, application No. 61/237,571, filed Aug. 27, 2009.

### BACKGROUND OF THE PRESENT INVENTION

1. Field of Invention

The present invention relates to a computer-based business exploitation system for searching business opportunities and its method thereof, and more particularly to a business exploitation system including a global map position search (GMPS) system and a target map search (TMS) system and method thereof for locating a product or service item with geographical distribution information and location illustration at a glance, that the illustration is meaningful and useful for business planning and development.

2. Description of Related Arts

The increasing growing number of web users has led to golden opportunities in relation to e-commerce and business opportunities utilizing the internet, including both the public and the private network, which is a powerful communication tool. Activities such as online trading, researching, sourcing, online auction, marketing, social or professional networking, information exchange in forum, and sharing information through a blog provides an enormous amount of information in the internet world which is resourceful to a user. However, this leads to the problem of finding a particular piece of information in the internet very difficult, time consuming or ineffective.

For example, when a user needs to find an item A, he or she may go to the popular search engines such as GOOGLE, YAHOO, BING, or etc., type in the name or keyword and wait for the results. Depending on the search criteria as typed, a list of results will be returned. Most of the time, tens to hundreds or thousands of results will be found and the user is required to go to each result item to verify the accuracy and usefulness of the result item. The listing of each result item, lacking organization in any manner is meaningless to the user. The listing is just like a world reference book without an index, failing for providing a quick and easy accessible reference to the user.

The conventional search engines make use of the popularity of a web location (or website) or the percentage of key word matching for searching. Therefore, the results are displayed in a compilation of listing with bias towards big or dominant corporations which have power and resources to maintain a strong internet presence. In other words, a user who is looking for an alternative for the big and/or dominant corporations, he or she cannot really avoid it.

The problem of lacking indexing or big corporation dominance is particularly obvious for an individual user or for a small to medium company utilizing the internet for shopping or trading related activities, who lacks resources to go through every single result item on the search result list, which is in fact a very long list in general. This greatly affects the business exploitation of the internet, which is very important in today's' world. For example, a start-up company is hard to locate available business opportunities at global or local level, by simply looking at the listing of search results.

In addition, the search result list is a plain compilation without any categorization or additional/accessory geographical information, which is fundamental to an effective search result list, especially for individual users, local and small businesses. Though it is possible to type in the name of the city or district to narrow down a search request, it is largely relied on the knowledge of the user in a particular area. It is interesting to see that a user who is unfamiliar with the area could not really get help through searching over the internet while it is the user who is familiar with the area could get and make use of the information as provided in the internet. Unfortunately, it is the user who is unfamiliar with the area really in need of the help from the information as provided in the internet.

Another drawback is that the search result list which does not provide the geographical distribution or related information such as quantity, buy/sell statistics or bargaining deal has failed to facilitate the businesses' need, such as the need to look for wholesalers or retailers for a product, in view of the ever growing internet related trading activities. This holds true for the wholesalers, retailers, small local businesses, and sole proprietors who need to know the information in relation to location, pricing, trading history or distribution in order to exploit trading and business opportunities. The lack of categorization and additional geographical information fails to consider the businesses' need, thereby limiting the growth of business activities.

### SUMMARY OF THE PRESENT INVENTION

The invention is advantageous in that it provides a global map position search (GMPS) system and a target map search (TMS) system and method for locating a product or service item with geographical distribution information and location at a glance, which is both buyer and seller friendly, so as to enhance the business exploitation through the internet.

Another advantage of the invention is to provide a computer-based business exploitation system for searching business opportunities and its method thereof in which a global map position search (GMPS) system and a target map search (TMS) system and method thereof are provided for locating a product or service item with geographical distribution information and location illustration at a glance, that the illustration is meaningful and useful for business planning and development.

Another advantage of the invention is to provide a computer-based business exploitation system for searching business opportunities and its method thereof, which includes a global map position search (GMPS) system and a target map search (TMS) system for searching business opportunities, and a network system for assisting buying, selling, auction, advertisement and community activities.

Another advantage of the invention is to provide a computer-based business exploitation system, allowing a business entity to join and acquire a member status for the business entity, such that when the business entity is included in a search result, its contact information and additional information is obtainable through the system.

Additional advantages and features of the invention will become apparent from the description which follows, and may be realized by means of the instrumentalities and combinations particular point out in the appended claims.

According to the present invention, the foregoing and other objects and advantages are attained by a business search method of a business exploitation system including a system server having a central processing unit controlling a system database, adapted for communicating with a network and one or more terminals through the network, through a global map position search (GMPS) system to provide a GMPS method, that the GMPS method comprises the steps of:

conducting a GMPS search step if a GMPS search request is received from the terminal through the network to obtain a GMPS search result, wherein the GMPS search result contains one or more search result units;

translating the GMPS search result to match a geographical location on a map to generate a geographical spot on the map, wherein one geographical spot is generated for one search result unit and each geographical spot represents one real address of a business entity; and

communicating with the terminal for visually displaying all the result units as geographical spots on the map, wherein the GMPS search step is controlled by the GMPS system for conducting the search step through the network and the GMPS search request includes at least a keyword for a product or service item.

In accordance with another aspect of the invention, the present invention comprises a business search method of a business exploitation system including a system server having central processing unit controlling a system database, adapted for communicating with a network and one or more terminals through the network, through a target map search (TMS) system to provide a TMS method, that the TMS method comprises the steps of:

conducting a TMS search step if a TMS search request is received from the terminal through the network to obtain a TMS search result, wherein the TMS search result contains one or more search result units;

translating the TMS search result to match a geographical location on a map to generate a geographical spot on the map, wherein one geographical spot is generated for one search result unit and each geographical spot represents one real address of a business entity; and

communicating with the terminal for visually displaying all the search result units as geographical spots on the map, wherein the TMS search step is controlled by the TMS system for conducting the search step through the network and the TMS search request includes at least one keyword for a product or service item and a category for the product or service item.

In accordance with another aspect of the invention, the present invention comprises a business exploitation system including a system server having central processing unit controlling a system database, adapted for communicating with a network and one or more terminals through the network, comprising:

a networking system for enrolling members and information sharing between the members, wherein the network system is adapted for assigning a member status to the business entity if the business entity completes a member application which requires a contact information including at least a real business address and is stored in the system database of the business exploitation system;

a global map position search (GMPS) system for providing a GMPS method comprises the steps of:

conducting a GMPS search step if a GMPS search request is received from the terminal through the network to obtain a GMPS search result, wherein the GMPS search request includes at least a keyword for a product or service item and the GMPS search result contains one or more search result units;

translating the GMPS search result to match a geographical location on a map to generate a geographical spot on the map, wherein one geographical spot is generated for one search result unit and each geographical spot represents one real address of a business entity; and

communicating with the terminal for visually displaying all the result units as geographical spots on the map; and

a target map search (TMS) system for providing a TMS method which comprises the steps of:

conducting a TMS search step if a TMS search request is received from the terminal through the network to obtain a TMS search result, wherein the TMS search request includes at least a keyword for a product or service item and a category for the product or service item and the TMS search result contains one or more search result units;

translating the TMS search result to match a geographical location on a map to generate a geographical spot on the map, wherein one geographical spot is generated for one search result unit and each geographical spot represents one real address of a business entity; and

communicating with the terminal for visually displaying all the search result units as geographical spots on the map;

wherein a category is assigned for each search result unit, wherein a plurality of sub-categories is preset under the category for further classification of the search results units to related to one of the sub-categories, wherein a preset category symbol is used for each sub-category, wherein the category symbols for different sub-categories are different, thereby all the search result units as geographical spots on the map further provides the sub-category of the search result units on the map;

wherein the networking system is further arranged for linking the contact information of the business entity having a member status to the corresponding geographical spot of the business entity on the map such that the contact information of the business entity is viewable through the corresponding geographical spot on the map.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is an illustration of communication relationships of a computer-based business exploitation system of a preferred embodiment of the present invention.

FIG. 2 is an exemplary illustration of an interface of the computer-based business exploitation system of the preferred embodiment of the present invention.

FIG. 3 is an exemplary illustration of an interface of the global map position search (GMPS) of the preferred embodiment of the present invention.

FIG. 4 is an exemplary illustration of an interface of the target map search (TMS) of the preferred embodiment of the present invention.

FIG. 5 is another exemplary illustration of an interface of the target map search (TMS) of the preferred embodiment of the present invention.

FIG. 6 is another exemplary illustration of an interface of the target map search (TMS) of the preferred embodiment of the present invention.

FIG. 7 is another exemplary illustration of an interface of the target map search (TMS) of the preferred embodiment of the present invention.

FIG. 8 is another exemplary illustration of an interface of the target map search (TMS) of the preferred embodiment of the present invention.

FIG. 9 is an exemplary illustration of the construct of the business exploitation system and method of the preferred embodiment of the present invention.

### DETAILED DESCRIPTION OF THE PREFERRED EMBODIMENT

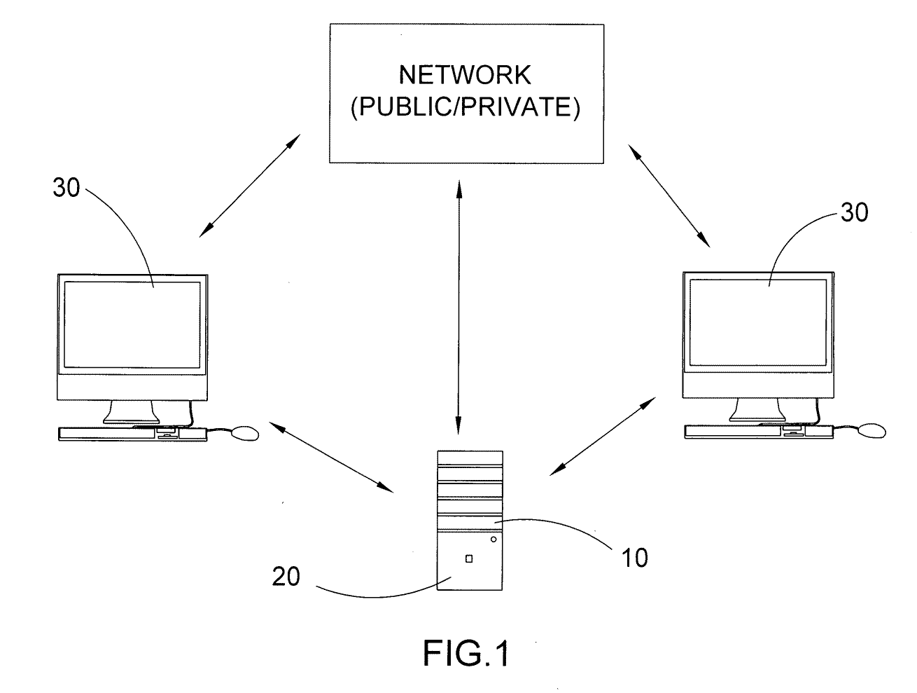

Referring to FIGS. 1 to 9 of the drawings, a search engine system and method for searching and translating the result onto a map according to a preferred embodiment of the present invention is illustrated. The search engine system includes a global map position search (GMPS) system and a target map search (TMS) system, adapted for locating a product or service item and providing the geographical distribution information and location for a user at a glance.

The system of the present invention, which is controlled by a system provider who may be an individual, a corporation or a business entity, comprises a system server 10 with a central processor unit 11 and a system database 20 for storing data and information which is accessible through the system server 10, adapted for communicating with a network for searching a search object, that the network can be a public network or a private network, to obtain a search result, which is then translated into a search location on a map 40, visually depicted as a geographical spot 41 and viewable on a display on a terminals 30 through the network. In addition a map scale 43 is also provided and viewable on the same screen of the display.

Preferably, the map 40 is stored in the system database 20. Each of the geographical spots 41 represents one business entity, which is positioned on the map 40 according to a business address of the business entity.

The system server 10 comprises a global map position search (GMPS) system 51 and a target map search (TMS) system 52 to provide a method for locating a product or service item with geographical distribution information and location at a glance.

The GMPS system includes a GMPS searching method comprising the steps of:

(1a) conducting a GMPS search step upon receiving a GMPS search request from a terminal 30 through a network to obtain a GMPS search result; and

(1b) translating the GMPS search result to match a graphical spot on a map stored in or accessible and controlled by the system database 20 and communicating with the terminal 30 for visually displaying the search result on the map.

The target map search (TMS) system includes a TMS searching method comprising the steps of:

(2a) conducting a TMS search step upon receiving a TMS search request from a terminal through a network to obtain a TMS search result; and

(2b) translating the TMS search result to match a graphical spot on a map stored in the system database 20 and communicating with the terminal 30 for visually displaying the search result on the map.

Before step (2a), the method may further comprise the following step:

(2a′) presetting a level of a map according to a user's selection, wherein the map at global level is set as the default level if the user's selection is not received.

Preferably, the user may select the map at global level or at country level for searching through the TMS searching method. In the TMS search request, the user is required to enter a keyword to complete the TMS search request. Optionally, the user can select or enter a country and/or a category for the TMS search request to narrow down the search. Alternately, the user may also point to any part of the map to preset the map at a particular level.

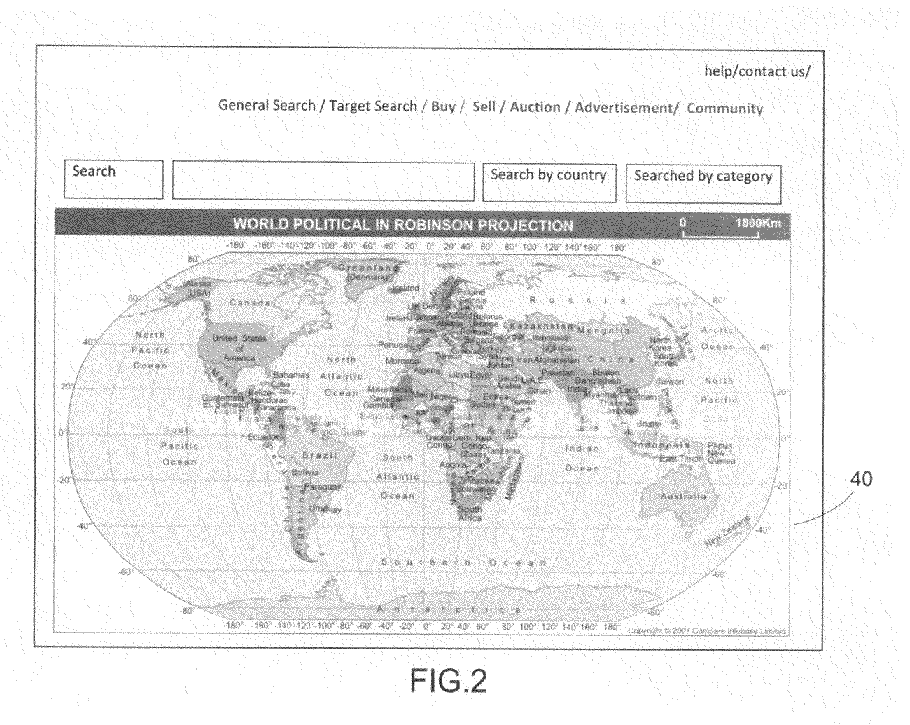

Referring to FIG. 2 of the drawings, the system of the present invention further comprises a buyer search method comprising the steps of:

(3a) conducting a buyer search step upon receiving a buyer search request from a terminal through a network to obtain a buyer search result; and

(3b) translating the buyer search result to match a graphical spot on a map stored in the system database 20 and communicating with the terminal 30 for visually displaying the search result on the map.

Preferably, in step (3a), the buyer search step includes the categories of manufacturer, distributor, wholesaler and retailer in the buyer search, and the buyer search method further comprises the following step:

(3c.1) assigning a category symbol 411 for each category such that different category symbols 411 are used to depict the different categories of the buyer search result; and

(3c.2) visually displaying the search result on the map in which each search result is visually displayed by the corresponding category symbol 411 it belongs to, thereby allowing the user viewing the category of each buyer search result on the map at a glance.

For example, a retailer can make use of the buyer search method to locate wholesalers, a wholesaler can make use of the buyer search method to locate distributor, and a distributor can make use of the buyer search method to locate manufacturer. When a retailer uses the buyer search method to locate wholesalers, the retailer can quickly know the category of the search result through the category symbol 411 of the search result, therefore identifying the wholesalers and their corresponding locations on the map as shown immediately or without any further steps.

Preferably, the buyer search method further comprises the following step:

(3d.1) classifying the buyer search result as a member status or non-member status; and

(3d.2) linking an accessory information to the buyer search result if the buyer search result has a member status and contains the accessory information, such that the accessory information will be displayed through the buyer search result.

The accessory information may be viewed in the same window, in a separate window, in a pop-up screen or as a link which includes additional address, telephone number, facsimile number, website address, contact person, email address, short comment or note as provided by the particular business entity.

Referring to FIG. 2 of the drawings, the system of the present invention further comprises a seller method comprising the steps of:

(4a) generating a seller market place in response to a seller request of a seller from a terminal 30 through a network; and

(4b) assigning a seller category to the seller according to a seller category information of the seller request.

The seller category includes a plurality of sub-categories such as brand, manufacture, distributor, wholesale, retail, headquarter, branch office, etc., which is based on the seller category information as provided by the seller and is determined by the system.

It is worth mentioning that the seller is required to provide a real address in the seller request order to generate the seller market, wherein the real address is searchable through the GMPS and/or TMS system. Preferably, the seller also provides accessory information such as additional address, telephone number, facsimile number, website address, contact person, email address, short comment and/or note in the seller request such that the seller's information as provided will be displayed through the accessory information of the GMPS and TMS system. The accessory information may be viewed in the same window, in a separate window, in a pop-up screen or as a link.

Before step (4a), the method further comprises the following steps:

(4a.1) providing information and requirements for generating a seller market place in response to a seller request of a seller from a terminal 30 through a network; and

(4a.2) providing seller system assistance tool for generating the selling marketing place.

The seller system assistance tool may include software for setting up or designing an online store, building a payment interface, providing security protection, or etc. The seller's information in the seller request and the seller market place are stored in the system database. The seller market place is accessible through the network.

Referring to FIG. 2 of the drawings, the system of the present invention further comprises an auction method comprising the steps of (5a.1) posting an auction project such as projects for distribution or dealer's rights in response to an auction request of an auction initiator from a terminal 30 through a network.

In the auction request, the auction initiator is required to provide an auction information and/or an auction requirement which are preset in the system database 20 of the system. For example, the auction information may provide the minimum bid requirement (such as US$100.00), an auction time frame (such as one-month, two-month or three-month); and the auction requirement may require interested parties such as potential bidders or buyers to make formal applications, to sign credit contract, to provide a letter of credit (L/C) and to pay a security deposit. The auction project is stored in the system database and is accessible through the network.

It is worth mentioning that the auction project may employ a price bid or a plan bid, open or non-open to the bidders involved. The price bid means the bidder offering the highest bidding price will get the bid. The plan bid means the auction initiator set up a plan and lists all the requirements to determine the winner of the bid. Preferably, the auction project is a price bid which requires a bid handling charge for each bid to be valid.

Alternately, the auction method comprises the following steps:

(5a.2) posting a business promotion project such as business project for attracting and inviting investment, partners and buyers in response to an auction request of an auction initiator from a terminal 30 through a network.

In the auction request, the auction initiator is required to provide a business plan, to pay a security deposit, to sign a contract with the system provider, and the business promotion project may be open to public, related parties only, referrals only or members only for achieving the business promotion purposes. The business promotion project is stored in the system database 20 and is accessible through the network. Accordingly, the auction initiator can make use of the system of the present invention for selling or attracting investment for brand named products, general products, services in cultural, arts, legal, transportation and food industries, electronic business service providers, country specific projects or items, conventional centers, and the like, that the system of the present invention is a powerful business tool for promoting business activities.

Referring to FIG. 2 of the drawings, the system of the present invention further comprises an advertisement method comprising the step of:

(6a) providing an advertisement section which is viewable when a terminal is communicating with the system server 10.

The advertisement section is opened for advertisement buyers through bidding or buying, may be classified or subdivided based on the geographical location according to a real address of the buyers.

In particular, the advertisement method further comprises the step of:

(6b) assigning the advertisement section to the advertisement buyer if the advertisement buyer buys the advertisement section and the advertisement section is opened for buying; and

(6c) assigning the advertisement section to the advertisement buyer if the buyer offers the highest bid for the advertisement section and the advertisement section is opened for bidding.

The advertisement buyer is required to provide a real address and fulfill the advertisement terms and conditions as required by the system provider. In step (6c), alternately, the best bid may be used instead of the highest bid. For example, the best bid may put geographical location of the advertisement buyer as one additional consideration.

Referring to FIG. 2 of the drawings, the system of the present invention further comprises a community building method for information sharing and discussion comprising the step of:

(7a) providing a community section which is viewable through a terminal when the terminal is communicating with the system server 10.

The community section includes a news section interactively linked to a plurality of news sources through the network for obtaining current news information from the news sources which is viewable through the terminal 30 communicating with the system server 10 and a forum section adapted for receiving sharing information which is then stored in the system database 20, viewable and searchable through the terminal 30 communicating with the system server 10.

The community section may also further comprise a chatroom section, allowing different member users of the system to communicate openly or privately.

It is worth mentioning that the map 40 of the system is adjustable into different level or scale. For example, the map 40 can show the search result at a global level, at a regional level, at a country level, at a state/province level, at a city/district level, and at a street level, based on the preference of the user. In other words, the system further provides the search results in the map which can be zoomed from the global level to the street level. The scale of the map 40 is provided through the map scale 43.

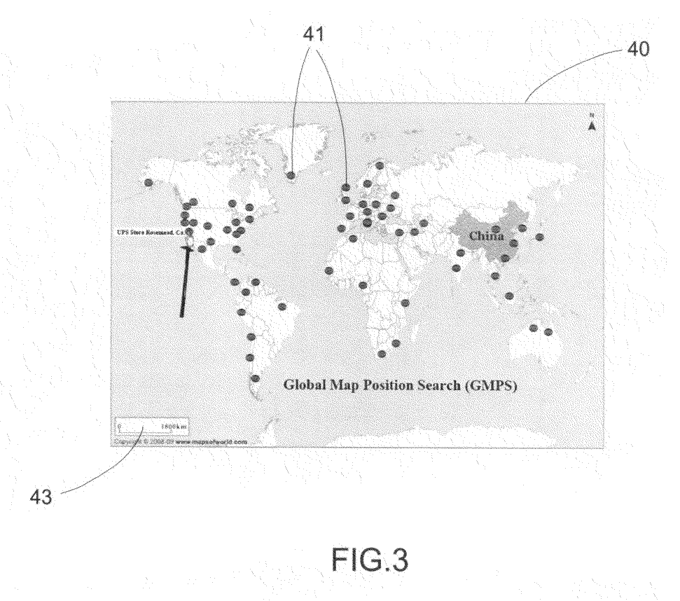

Referring to FIG. 3 of the drawings, the map showing the search results as the geographical spots at the global level is illustrated. In this example, “CHINA” is searched by the GMPS system using the GMPS method to provide the search results as the geographical spots at the global level. Therefore, the user can easily know the geographical distribution of different sales channels in the world for “CHINA”. By pointing to any one of the geographical spots on the map, a brief spot description is provided. The map of a particular area can also be adjusted or zoomed into different scales as desired by the user if a zooming signal is received. It is worth mentioning that the search result contains one or more search result units, each search result unit corresponds to one business entity and is represented by one geographical spot having a predetermined category symbol 411 corresponding to the category (and sub-categories) of the particular business entity. The category symbol 411 for the corresponding category (or sub-category) is arranged to illustrate through a map key 42 on the same screen of the display.

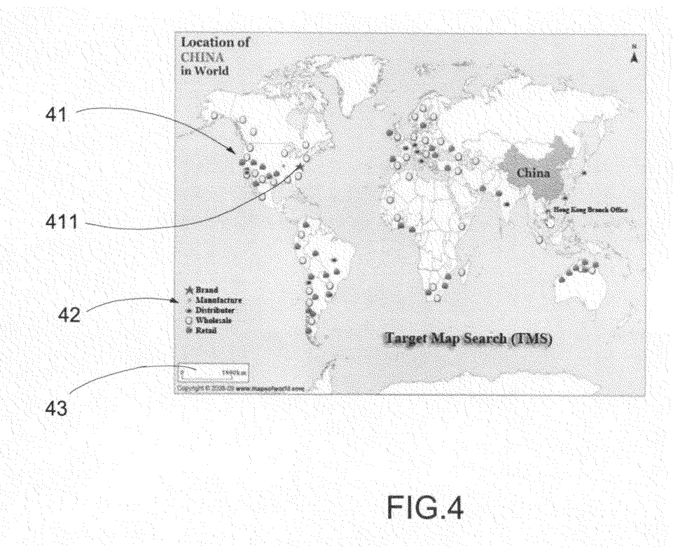

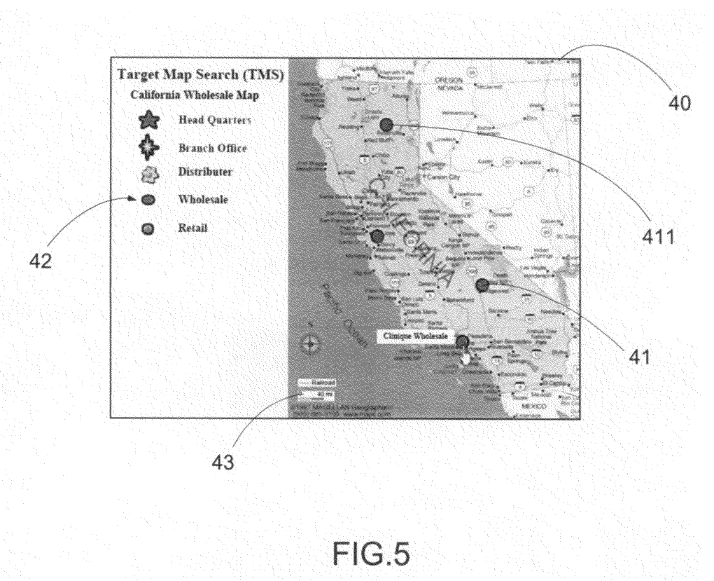

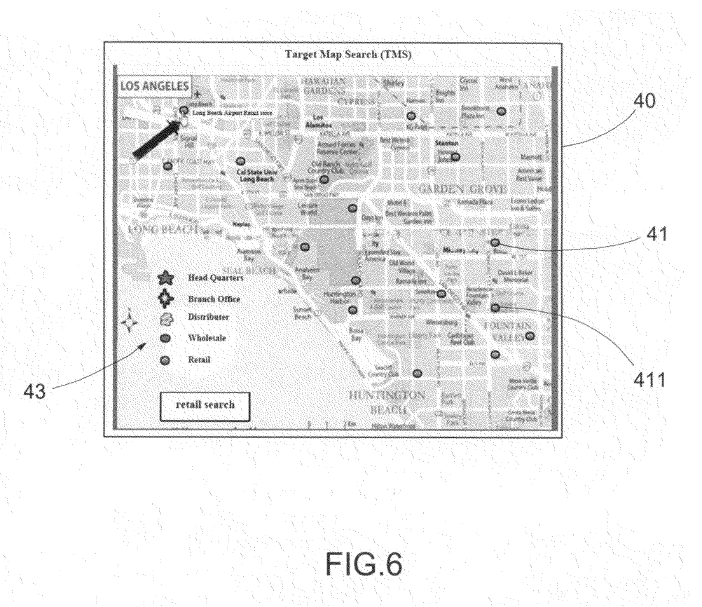

Referring to FIGS. 4 to 6 of the drawings, the map at global level, state level and street level are illustrated. In this example, “CHINA” is searched by the TMS system using the TMS method to provide the search results as the geographical spots on the map. The search results as shown in FIG. 4 are the geographical spots on the map at global level. The search results as shown in FIG. 5 are the geographical spots on the map at state level. The search results as shown in FIG. 6 are the geographical spots on the map at street level. Therefore, the user can look at the location of the search results at a glance, even if he or she does not have any knowledge about the location or vicinity.

It is worth mentioning that the search result contains one or more search result units, each search result unit corresponds to one business entity and is represented by one geographical spot having a predetermined category symbol 411 corresponding to the category (and sub-categories) of the particular business entity. Accordingly, the user can also identify the category (and sub-categories) of each search result unit of the search results provided by the TMS system in which different category symbols 411 are used for different categories respectively.

Referring to FIG. 4 of the drawings, the category includes brand, manufacture, distributor, wholesale and retail and different category symbols 411 are used for each item under the category. Accordingly, the user can instantly knows the category level and the location of the search results of a product. In other words, the user can obtain, for example, the location of the product CHINA by referring to the map as shown. That is to say, the system enables a user to know the brand, manufacture, distributor, wholesale and retail location of CHINA and the potential marketing target or product source at global level at a glance. If the user is interested in any particular area, he can simply zooms into that particular area and obtain further detailed information through the system of the present invention. If the user is interested in getting further information of the search result of a particular geographical spot on the map, he can simply point at the spot to obtain further information such as contact information, accessory information and business information. For example and as shown in FIG. 4, further information which is “Hong Kong Branch Office” is shown for the geographical spot as selected by the user.

Referring to FIG. 5 of the drawings, the category includes head quarter, branch office, distributor, wholesale and retail and different category symbols 411 are used for each item under the category. As shown, the category symbols 411 for headquarter, branch office, distributor, wholesale and retail are star, sun, sunflower, single circle and two overlapped circles respectively. Accordingly, the user can instantly know the category level and the location of the search results for a product. In other words, the user can obtain, for example, the wholesale location of the product of CLINIQUE, by referring to the map as shown, which is a helpful business tools, both for business planning and development. This is particularly useful when the user is new to the location or to the product. That is to say, the system enables a user to know the wholesale location of CLINIQUE at a glance.

Referring to FIG. 6 of the drawings, the category includes head quarter, branch office, distributor, wholesale and retail and different category symbols 411 are used for each item under the category. As shown, the category symbols 411 for headquarter, branch office, distributor, wholesale and retail are star, sun, sunflower, single circle and two overlapped circles respectively. The map as shown is at city level. When a user is desired to look for “CHINA” in Long Beach, he can get the search results as geographical spots on the map at city level at a glance. He can then decide whether he should drive to the retail store or to a wholesale store, or even to the manufacturer directly based on the distribution of headquarter, branch office, distributor, wholesaler and retailer in the city. Furthermore, he can also get a better estimation or understanding in relation to the cost of transportation, making a more accurate and appropriate business decision on geographical location factor.

Referring to FIG. 6 of the drawings, the search results in the vicinity city are also obtained through the TMS search system. The user is able to know if there's any available retail store or wholesale store in the vicinity city. In this way, the system can assist the user to widen the search to the vicinity city while setting a geographical limit. The user can also adjust the position of the map to show the vicinity area if desired.

Preferably, in the TMS system, the category which is preset for brand named products are: headquarter (including factory), branch office (in all countries), distributor, wholesaler and retailer; the category preset for general products are: headquarter (including factory), branch office (in all countries), distributor, wholesaler and retailer; the category preset for general service providers are: headquarter, branch office (in different countries) and agent (of each country) in one of the following industries: cultural, arts, legal, transportation, food, and etc; and the category preset for electronic business providers are: headquarter, branch office (in different countries) and agent (of each country).

It is worth mentioning that since the search results are indicated on the map 40 according to their corresponding geographical locations, the search results related to businesses of all sizes can be displayed and located. Unlike the conventional search results which are a plain listing, the display of which is limited by width and height of the display and cannot be shown on one screen of the display, the present invention provides a system which can show all the search results on the map 40 while allowing the user to narrow down the search results based on geographical location, thereby effectively offering the users an effective search system and method to provide search results as geographical spot on a map at a glance.

Preferably, the system of the present invention may also further include a business information database in the system database, adapted for storing business information related to products and services linked to the search results as geographical spots. In particular, the business information includes sales volume, discount offer, promotional offer, level of trading activities, and the like. Therefore, when a user enters the TMS or GMPS search system to search for a product, he or she will get the business information in relation to the product for each search result as geographical spot on the map through the business information database of the system of the present invention. For example, similar to the method of showing accessory information which is shown in FIG. 4, the business information is linked to each geographical spot and is displayed when selected by the user.

It is worth mentioning that the TMS search request may also include a category in the search request to narrow down the search. For example, when a user is looking for retail stores of a product in Los Angeles, he may use the TMS system, entering the keyword of the product, entering the location which is “Los Angeles” or pointing to the corresponding location of “Los Angeles” on the map 40, and entering the category which is “retail”, as shown in FIG. 6, to get the search results containing retail stores only, which is a retail search under the TMS system.

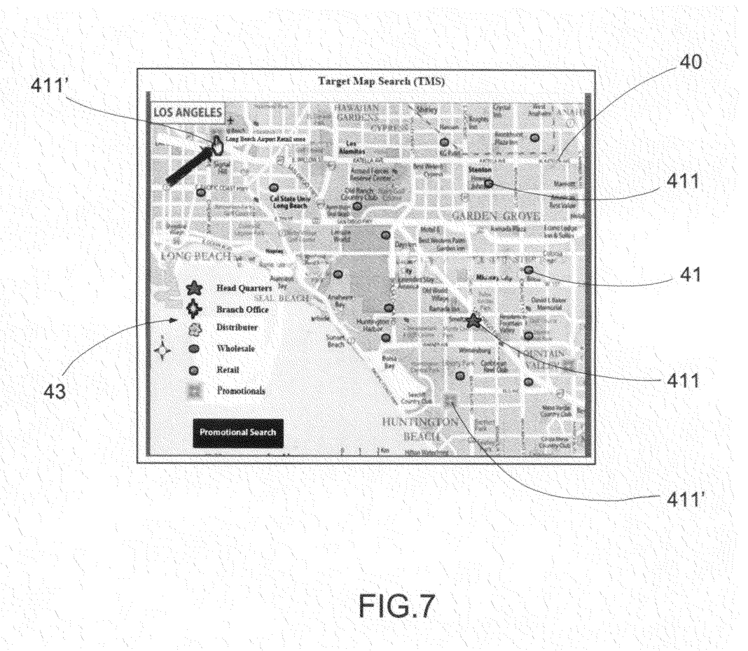

The category further includes a prioritized sub-category for showing a particular nature of the search result unit. The prioritized sub-category is represented by a preset category symbol 411, and preferably by a preset category symbol having special blinking effect or eye-catching effect 411′. For example, referring to FIG. 7 of the drawings, the sub-category “promotional” is used for indicating a business entity having a promotional event on the map 40, which is presented by the preset category symbol 411′. The sub-category “promotional” is shown in the map 40 when a search result unit corresponds to a business entity having a promotional event or offer for sales, discount offer, seasonal sales, closing sales, free complimentary offer and the like. Preferably, the category symbol 411′ for “promotional” is arranged to have a blinking effect or an eye-catching effect when shown on the map 40. It is worth mentioning that the prioritized sub-category has priority over other sub-categories and the category symbol 411′ for the prioritized sub-category such as “promotional” is arranged to be displayed for showing promotion event or offer of manufacturers, distributors, wholesalers, retailers and other type of business entities. In other words, when a wholesaler has a sale event, the category symbol 411′ for the prioritized sub-category such as “promotional” is displayed on the map 40 and the category symbol 411 for the sub-category “manufacture” is not used for representing the manufacturer having a promotional event.

It is worth mentioning that an alternative of the TMS search is modified to further comprising a business activity search and a promotional search specified for limiting the search to show the business activities and promotional events respectively.

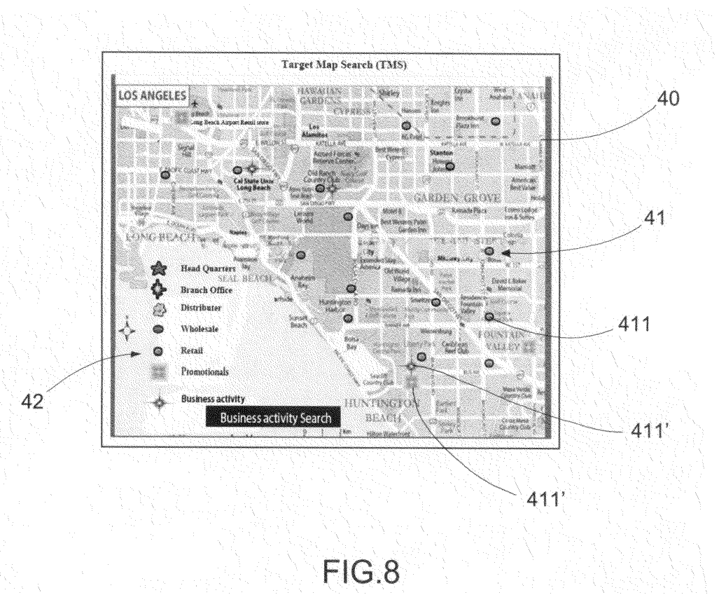

Referring to FIG. 8 of the drawings, the category includes two prioritized sub-categories “promotional” and “business activity” as an example. The sub-category “promotional” is arranged for indicating a business entity having a promotional event on the map 40, which is presented by a preset category symbol 411′, as described above. The sub-category “business activity” is arranged for indicating an address having a large scale event such as auction event or investment and development project related events on the map 40, which is presented by a preset category symbol 411′. The sub-category “business activity” is shown in the map 40 when a search result unit corresponds to a business entity having a large scale event such as auction events, project bidding events and investment seminars at an address. Preferably, the category symbol 411′ for “business activity” is arranged to have a blinking effect or an eye-catching effect when shown on the map 40. It is worth mentioning that the prioritized sub-category has priority over other sub-categories and the category symbol 411′ for the prioritized sub-category such as “promotional” and “business activity” are arranged to be displayed for showing promotion events or offers and business activities of manufacturers, distributors, wholesalers, retailers and other type of business entities. In other words, for example, when a branch office has a large scale investment seminar, the category symbol 411′ for the prioritized sub-category such as “business activity” is displayed on the map 40 and the category symbol 411 for the sub-category “branch office” is not used for representing location of the branch office having a large scale investment seminar.

It is worth mentioning that the accessory information or the business information may also be provided by a particular business entity in the member application and enrolment or updated upon the request of the particular business entity.

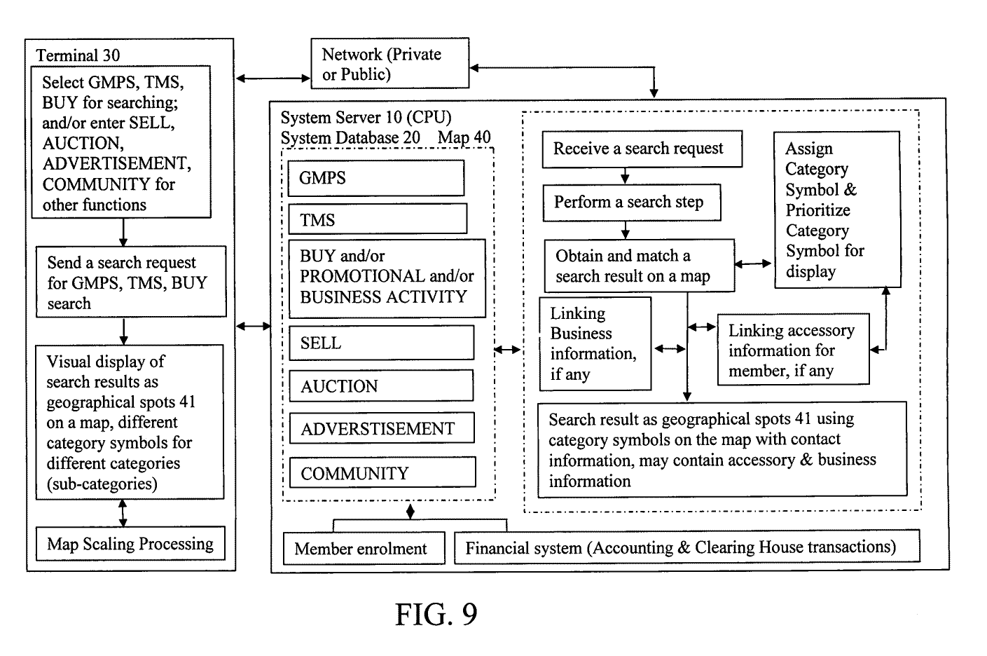

Referring to FIG. 9 of the drawings, the construct of the business exploitation system and method of the preferred embodiment of the present invention is illustrated. The business exploitation system including a system server 10 having central processing unit 11 controlling a system database 20, adapted for communicating with a network and one or more terminals through the network, comprising a networking system, a global map position search (GMPS) system and a TMS system.

Preferably, the system has a first preset language which is English and is arranged to provide a translation from the first preset language to one or more official languages for users in different countries.

The networking system is arranged for enrolling members and information sharing between the members, wherein the network system is adapted for assigning a member status to the business entity if the business entity completes a member application which requires a contact information including at least a real business address and is stored in the system database of the business exploitation system.

It is worth mentioning that the members can be further divided into a plurality of subclasses. For example, the members are divided into three subclasses such as “Trust” member, “Premier member” and “Normal member”. Based on activities and usage of a particular member, the networking system analyzes and determines the subclass of the particular member which is then linked to the accessory information of the particular member and is viewable when the particular member is shown in the system. Preferably, the “Trust” member has the highest creditworthiness and the “Premier” member has an above average creditworthiness.

The global map position search (GMPS) system for providing a GMPS method comprises the steps of:

(a.1) conducting a GMPS search step if a GMPS search request is received from the terminal through the network to obtain a GMPS search result, wherein the GMPS search request includes at least a keyword for a product or service item and the GMPS search result contains one or more search result units;

(a.2) translating the GMPS search result to match a geographical location on a map to generate a geographical spot on the map, wherein one geographical spot is generated for one search result unit and each geographical spot represents one real address of a business entity; and

(a.3) communicating with the terminal for visually displaying all the result units as geographical spots on the map.

The target map search (TMS) system for providing a TMS method which comprises the steps of:

(b.1) conducting a TMS search step if a TMS search request is received from the terminal through the network to obtain a TMS search result, wherein the TMS search request includes at least a keyword for a product or service item and a category for the product or service item, wherein the TMS search result contains one or more search result units;

(b.2) translating the TMS search result to match a geographical location on a map to generate a geographical spot on the map, wherein one geographical spot is generated for one search result unit and each geographical spot represents one real address of a business entity; and

(b.3) communicating with the terminal for visually displaying all the search result units as geographical spots on the map.

The search result includes a category is assigned for each search result unit, wherein a plurality of sub-categories is preset under the category for further classification of the search results units to related to one of the sub-categories, wherein a preset category symbol 411 is used for each sub-category, wherein the category symbols 411 for different sub-categories are different, thereby all the search result units as geographical spots on the map further provides the sub-category of the search result units in the map.

Preferably, the category provides five sub-categories for brand named products to provide classification for headquarter, branch office, distributor, wholesale and retail; wherein the category provides five sub-categories for general products to provide classification for brand, manufacture, distributor, wholesale and retail; wherein the category provides three sub-categories for service to provide classification for headquarter, branch office and agent.

It is worth mentioning that the networking system is further arranged for linking contact information of the corresponding geographical spot of the business entity on the map such that the contact information of the business entity is viewable through the corresponding geographical spot on the map. When the business entity as shown is a member and when accessory information of the business entity is available, the accessory information is also arranged to link to the corresponding geographical spot on the map 40.

In addition, the networking system is arranged for linking a business information of the business entity to the corresponding geographical spot of the business entity on the map when the system database contains the business information of the business entity such that the business information of the business entity is viewable through the corresponding geographical spot on the map. The business information contains sales volume, discount offer, promotional offer, level of trading activities, and the like, which is stored in the accessory information database of the system.

Preferably, the map is stored in the system database and is preset at a global level, adapted for zooming to enlarge in such a manner that each of the geographical spot is capable of being shown on the map at a street level. For the TMS search request, it is possible to include a country for limiting the search step to the country as selected, such that the map as displayed in the search result is then set at a country level.

In particular, when the category provides five sub-categories for general products to provide classification for brand, manufacture, distributor, wholesale and retail, the TMS method further comprises the steps of:

(b.4.1) assigning the brand category to a search result unit if the geographical spot is related to a brand product;

(b.4.2) assigning the manufacture category to a search result unit if the geographical spot is related to a manufacturer of a product;

(b.4.3) assigning the distributor category to a search result unit if the geographical spot is related to a distributor of a product;

(b.4.4) assigning the wholesale category to a search result unit if the geographical spot is related to a wholesaler of a product; and

(b.4.5) assigning the retail category to a search result unit if the geographical spot is related to a retailer of a product.

In particular, when the category provides five sub-categories for brand named products to provide classification for headquarter, branch office, distributor, wholesale and retail, the TMS method further comprises the steps of:

(b.4.1′) assigning the headquarter category to a search result unit if the geographical spot is related to a headquarter or a manufacturer of a product;

(b.4.2′) assigning the branch office category to a search result unit if the geographical spot is related to a branch office of a product;

(b.4.3′) assigning the distributor category to a search result unit if the geographical spot is related to a distributor of a product;

(b.4.4′) assigning the wholesale category to a search result unit if the geographical spot is related to a wholesaler of a product; and

(b.4.5′) assigning the retail category to a search result unit if the geographical spot is related to a retailer of a product.

The networking system is further arranged to provide a buyer search method for the members comprising the steps of

(e.1) conducting a buyer search step if a buyer search request is received from the terminal through the network to obtain a buyer search result, wherein the buyer search request includes at least a keyword for a product or service and the buyer search result contains one or more search result units;

(e.2) translating the buyer search result to match a geographical location on a map to generate a geographical spot on the map, wherein one geographical spot is generated for one search result unit and each geographical spot represents one real address of a business entity;

(e.3) communicating with the terminal for visually displaying all the result units as geographical spots on the map; and

(e.4) linking an accessory information of the business entity having a member status to the corresponding geographical spot of the business entity on the map when the system database contains the accessory information of the business entity such that the accessory information of the business entity is viewable through the corresponding geographical spot on the map.

The accessory information includes information such as additional address, telephone number, facsimile number, website address, contact person, email address, short comment and/or note of the particular business entity.

The networking system is further arranged to provide a seller search method comprising the steps of:

(f.1) generating a seller market place in response to a seller request of a seller; and

(f.2) assigning a sub-category to the seller according to a seller category information of the seller request.

The networking system is further arranged to provide an auction method comprising the step of:

(g) posting an auction project in response to an auction request of an auction initiator for the auction project, or

(g′) posting a business promotion project for attracting and inviting investment, partners and buyers in response to an auction request for the business promotion project.

It is worth mentioning that the map 40 in the system is a global map which is arranged to classify into five continents, namely Asia, Europe, America, Australia and Africa, each of which is further divided into regions and country level. When an auction project is posted, the auctioneer is capable of making use of the classification of the map 40 to restrict the number of opening for each particular region or country. For example, when an auction project of a new product is posted in the system, the system is arranged to place one branch office opening for each continent excluding headquarter and one distributor for each country by default, and is capable of setting a minimum distance between two openings such that the auctioneer can make use of the system for global business planning. Accordingly, for large scale multinational business projects, the system is effective for business planning based on the provision of the map and classification of the map, facilitating business planning through illustrations on the map 40. Alternately, the global map can also be arranged to classify into six continents, which are Asia, Europe, North America, South America, Australia and Africa.

The networking system is further arranged to provide an advertisement method comprising the step of:

(h) providing an advertisement section which is viewable when a terminal is communicating with the system server, wherein the advertisement section is required to contain at least a real address of an advertiser.

It is worth mentioning that the advertisement section is arranged for matching a geographical location on the map 40 of the system to generate a geographical spot on the map which represents the real address of the advertiser such that the geographical spot of the advertiser is capable of being displayed on the map. The advertiser, which is defined as a business entity, is searchable through the different systems of the present invention as a geographical location on the map. The geographical spot of the advertiser is linked to the contact information, the accessory information and the business information of the advertiser such that the contact information, the accessory information and the business information of the business entity is viewable through the corresponding geographical spot representing the business entity on the map. When the business entity has a website of his own, the geographical spot of the advertiser is further arranged to generate a link to the website of the advertiser such that a user can enter into the website of the advertiser through the system of the present invention.

The networking system is further arranged to provide a community building method for information sharing and discussion comprising the step of

(j) providing a community section which includes a news section interactively linked to a plurality of news source through the network for obtaining current news information from the news source which is viewable through the terminal communicating with the system server and a forum section adapted for receiving sharing information from the members which is then stored in the system database, viewable and searchable through the terminal communicating with the system server.

Preferably, the system further includes a centralized financial system for handling payment issues and a clearing house system for handling inter-countries transactions. For example, when an auction project of a product is posted in the system, the system is arranged to place one headquarter branch office opening for each continent and assign one headquarter branch office as a headquarter office, and one distributor for each country by default, and is capable of setting a minimum distance between two openings such that the auctioneer can make use of the system for global business planning. Accordingly, financial transaction such as cash or check transactions, between the headquarter, the headquarter branch offices and the distributors can be handled through the centralized financial system.

Preferably, some function of the system is restricted to members only. For example, auctioneers and sellers must be members for posting auction projects and seller market places.

As illustrated above, the system of the present invention provides graphical and geographical location containing business information, contact information and accessory information to a user on a map at a glance from the search results under the different systems such as GMPS, TMS and Buyer search systems of the present invention. Also, business tools such as Sell, Auction, Advertisement and Community system are provided. Accordingly, the system of the present invention provides a powerful tool for searching business entity as well as business planning and development.

It is worth mentioning that when the search result unit of the search system of the present invention is shown on the map 40, the search result unit is linked to geographical location containing business information, contact information and accessory information to a user on a map at a glance. In other words, a user is able to use the system of the present invention to look at the geographical location on the map 40 through a terminal 30 such as a personal computer and use the mouse to point at the geographical spot such that the associated information is displayed. When the business entity has its own website or has a market place of the present invention in the system, the user may also click on the geographical spot to go to the market place or the website of the business entity.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A business search method of a business exploitation system including a system server having central processing unit controlling a system database, adapted for communicating with a network and one or more terminals through the network, through a global map position search (GMPS) system to provide a GMPS method, that the GMPS method comprises the steps of:
(a.1) conducting a GMPS search step if a GMPS search request is received from the terminal through the network to obtain a GMPS search result, wherein the GMPS search result contains one or more search result units, wherein each search result unit represents one business entity;
(a.2) translating the GMPS search result to match a geographical location on a map to generate a geographical spot on the map, wherein one geographical spot is generated for one search result unit and each geographical spot represents one real address of the business entity; and
(a.3) communicating with the terminal for visually displaying all the result units as geographical spots on the map,
wherein the GMPS search step is controlled by the GMPS system for conducting the search step through the network and the GMPS search request includes at least a keyword for a product or service item.

2. The method, as recited in claim 1, wherein the map is stored in the system database and is preset to display at a global level, wherein the map is adapted for zooming to enlarge a particular area of the map in such a manner that each of the geographical spot is capable of being shown on the map at a street level.

3. The method, as recited in claim 2, wherein the search result unit is classified under a plurality of subcategories and assigned a category symbol corresponding to the subcategory of the search result unit accordingly, wherein each geographical spot is visually depicted through the corresponding category symbol such that the category of the business entity which is represented by the corresponding category symbol is visually displayed on the map.

4. The method, as recited in claim 3, wherein when the search result unit is associated with a business information for a promotional offer, a prioritized category symbol is assigned to replace the subcategory symbol such that the business entity is represented by the prioritized category symbol to visually display on the map.

5. A business search method of a business exploitation system including a system server having central processing unit controlling a system database, adapted for communicating with a network and one or more terminals through the network, through a target map search (TMS) system to provide a TMS method, that the TMS method comprises the steps of:
(b.1) conducting a TMS search step if a TMS search request is received from the terminal through the network to obtain a TMS search result, wherein the TMS search result contains one or more search result units, wherein each search result unit represents one business entity;
(b.2) translating the TMS search result to match a geographical location on a map to generate a geographical spot on the map, wherein one geographical spot is generated for one search result unit and each geographical spot represents one real address of the business entity; and
(b.3) communicating with the terminal for visually displaying all the search result units as geographical spots on the map,
wherein the TMS search step is controlled by the TMS system for conducting the search step through the network and the TMS search request includes at least a keyword for a product or service item and a category for the product or service item.

6. The method, as recited in claim 5, wherein the TMS search request further includes a country for limiting the search step to the country as selected, wherein the map as displayed in the terminal is set at a country level when the country is selected.

7. The method, as recited in claim 5, wherein the category provides five sub-categories to provide classification for brand, manufacture, distributor, wholesale and retail, wherein the method further comprises the steps of:
(b.4.1) assigning the brand category to a search result unit if the geographical spot is related to a brand product;
(b.4.2) assigning the manufacture category to a search result unit if the geographical spot is related to a manufacturer of a product;
(b.4.3) assigning the distributor category to a search result unit if the geographical spot is related to a distributor of a product;
(b.4.4) assigning the wholesale category to a search result unit if the geographical spot is related to a wholesaler of a product;
(b.4.5) assigning the retail category to a search result unit if the geographical spot is related to a retailer of a product;
(b.5) presetting a category symbol for each sub-category, wherein the category symbols for different sub-categories are different, thereby all the search result units as geographical spots on the map further provides the category of the search result units on the map.

8. The method, as recited in claim 6, wherein the category provides five sub-categories to provide classification for brand, manufacture, distributor, wholesale and retail, wherein the method further comprises the steps of:
(b.4.1) assigning the brand category to a search result unit if the geographical spot is related to a brand product;
(b.4.2) assigning the manufacture category to a search result unit if the geographical spot is related to a manufacturer of a product;
(b.4.3) assigning the distributor category to a search result unit if the geographical spot is related to a distributor of a product;
(b.4.4) assigning the wholesale category to a search result unit if the geographical spot is related to a wholesaler of a product;
(b.4.5) assigning the retail category to a search result unit if the geographical spot is related to a retailer of a product;
(b.5) presetting a category symbol for each sub-category, wherein the category symbols for different sub-categories are different, thereby all the search result units as geographical spots on the map further provides the category of the search result units in the map.

9. The method, as recited in claim 5, wherein the category provides five sub-categories to provide classification for headquarter, branch office, distributor, wholesale and retail, wherein the method further comprises the steps of:
(b.4.1′) assigning the headquarter category to a search result unit if the geographical spot is related to a headquarter or a manufacturer of a product;
(b.4.2′) assigning the branch office category to a search result unit if the geographical spot is related to a branch office of a product;
(b.4.3′) assigning the distributor category to a search result unit if the geographical spot is related to a distributor of a product;
(b.4.4′) assigning the wholesale category to a search result unit if the geographical spot is related to a wholesaler of a product;
(b.4.5′) assigning the retail category to a search result unit if the geographical spot is related to a retailer of a product;
(b.5) presetting a category symbol for each sub-category, wherein the category symbols for different sub-categories are different, thereby all the search result units as geographical spots on the map further provides the category of the search result units on the map.

10. The method, as recited in claim 6, wherein the category provides five sub-categories to provide classification for headquarter, branch office, distributor, wholesale and retail, wherein the method further comprises the steps of:
(b.4.1′) assigning the headquarter category to a search result unit if the geographical spot is related to a headquarter or a manufacturer of a product;
(b.4.2′) assigning the branch office category to a search result unit if the geographical spot is related to a branch office of a product;
(b.4.3′) assigning the distributor category to a search result unit if the geographical spot is related to a distributor of a product;
(b.4.4′) assigning the wholesale category to a search result unit if the geographical spot is related to a wholesaler of a product;
(b.4.5′) assigning the retail category to a search result unit if the geographical spot is related to a retailer of a product;
(b.5) presetting a category symbol for each sub-category, wherein the category symbols for different sub-categories are different, thereby all the search result units as geographical spots on the map further provides the category of the search result units in the map.

11. The method, as recited in claim 7, wherein when the search result unit is associated with a business information for a promotional offer, a prioritized category symbol is assigned to replace the category symbols of the subcategories such that the business entity is represented by the prioritized category symbol to visually display on the map.

12. The method, as recited in claim 8, wherein when the search result unit is associated with a business information for a promotional offer, a prioritized category symbol is assigned to replace the category symbols of the subcategories such that the business entity is represented by the prioritized category symbol to visually display on the map.

13. The method, as recited in claim 9, wherein when the search result unit is associated with a business information for a promotional offer, a prioritized category symbol is assigned to replace the category symbols of the subcategories such that the business entity is represented by the prioritized category symbol to visually display on the map.

14. The method, as recited in claim 10, wherein when the search result unit is associated with a business information for a promotional offer, a prioritized category symbol is assigned to replace the category symbols of the subcategories such that the business entity is represented by the prioritized category symbol to visually display on the map.

15. The method, as recited in claim 5, further comprises the steps of:
(c.1) assigning a member status to the business entity if the business entity complete a member application through the business exploitation system, wherein the member application requires a contact information including at least a real business address, wherein the business entity is capable of providing an accessory information and a business information in the member application; wherein the member application is stored in the system database of the business exploitation system; and
(c.2) linking the accessory information and the business information of the business entity to the corresponding geographical spot of the business entity on the map such that the accessory information and the business information of the business entity is viewable through the corresponding geographical spot representing the business entity on the map.

16. The method, as recited in claim 8, further comprises the steps of:
(c.1) assigning a member status to the business entity if the business entity complete a member application through the business exploitation system, wherein the member application requires a contact information including at least a real business address, wherein the business entity is capable of providing an accessory information and a business information in the member application; wherein the member application is stored in the system database of the business exploitation system; and
(c.2) linking the accessory information and the business information of the business entity to the corresponding geographical spot of the business entity on the map such that the accessory information and the business information of the business entity is viewable through the corresponding geographical spot representing the business entity on the map.

17. The method, as recited in claim 9, further comprises the steps of:
(c.1) assigning a member status to the business entity if the business entity complete a member application through the business exploitation system, wherein the member application requires a contact information including at least a real business address, wherein the business entity is capable of providing an accessory information and a business information in the member application; wherein the member application is stored in the system database of the business exploitation system; and
(c.2) linking the accessory information and the business information of the business entity to the corresponding geographical spot of the business entity on the map such that the accessory information and the business information of the business entity is viewable through the corresponding geographical spot representing the business entity on the map.

18. The method, as recited in claim 5, wherein the map is stored in the system database and is preset at a global level, adapted for zooming to enlarge in such a manner that each of the geographical spot is capable of being shown on the map at a street level.

19. The method, as recited in claim 6, wherein the map is stored in the system database and is preset at a global level, adapted for zooming to enlarge in such a manner that each of the geographical spot is capable of being shown on the map at a street level.

20. The method, as recited in claim 11, wherein the map is stored in the system database and is preset at a global level, adapted for zooming to enlarge in such a manner that each of the geographical spot is capable of being shown on the map at a street level.

21. The method, as recited in claim 12, wherein the map is stored in the system database and is preset at a global level, adapted for zooming to enlarge in such a manner that each of the geographical spot is capable of being shown on the map at a street level.

22. A business exploitation system including a system server having a central processing unit controlling a system database, adapted for communicating with a network and one or more terminals through the network, comprising:
a networking system for enrolling members and information sharing between the members, wherein the network system is adapted for assigning a member status to the business entity if the business entity complete a member application which requires a contact information including at least a real business address, wherein the business entity is capable of providing an accessory information and a business information in the member application, wherein the member application is stored in the system database of the business exploitation system;
a global map position search (GMPS) system for providing a GMPS method which comprises the steps of:
(a.1) conducting a GMPS search step if a GMPS search request is received from the terminal through the network to obtain a GMPS search result, wherein the GMPS search request includes at least a keyword for a product or service item and the GMPS search result contains one or more search result units, wherein each search result unit represents one business entity;
(a.2) translating the GMPS search result to match a geographical location on a map to generate a geographical spot on the map, wherein one geographical spot is generated for one search result unit and each geographical spot represents one real address of a business entity; and
(a.3) communicating with the terminal for visually displaying all the result units as geographical spots on the map; and
a target map search (TMS) system for providing a TMS method which comprises the steps of:
(b.1) conducting a TMS search step if a TMS search request is received from the terminal through the network to obtain a TMS search result; wherein the TMS search request includes at least a keyword for a product or service item and the TMS search result contains one or more search result units, wherein when the TMS search request includes a category for the product or service item, the TMS search result units are limited to the category as selected in the TMS search request, wherein when the TMS search request includes a country for the product or service item, the TMS search result units are limited to the country as selected in the TMS search request;
(b.2) translating the TMS search result to match a geographical location on a map to generate a geographical spot on the map, wherein one geographical spot is generated for one search result unit and each geographical spot represents one real address of a business entity; and
(b.3) communicating with the terminal for visually displaying all the search result units as geographical spots on the map;
wherein a category is assigned for each search result unit, wherein a plurality of sub-categories is preset under the category for further classification of the search results units to related to one of the sub-categories, wherein a preset category symbol is used for each sub-category, wherein the category symbols for different sub-categories are different, thereby all the search result units as geographical spots on the map further provides the sub-category of each of the search result units on the map through the category symbol;
wherein the networking system is further arranged for linking the contact information, the accessory information and the business information of the business entity to the corresponding geographical spot of the business entity on the map such that the accessory information and the business information of the business entity is viewable through the corresponding geographical spot representing the business entity on the map.

23. The system, as recited in claim 22, wherein the map is stored in the system database and is preset at a global level, adapted for zooming to enlarge in such a manner that each of the geographical spot is capable of being shown on the map at a street level.

24. The system, as recited in claim 22, wherein the TMS search request further includes a country for limiting the search step to the country as selected, wherein the map as displayed in the terminal is set at a country level.

25. The system, as recited in claim 22, wherein the category provides five sub-categories for general products to provide classification for brand, manufacture, distributor, wholesale and retail, wherein the steps (b.4) of the TMS method further comprises the steps of:
(b.4.1) assigning the brand category to a search result unit if the geographical spot is related to a brand product;
(b.4.2) assigning the manufacture category to a search result unit if the geographical spot is related to a manufacturer of a product;
(b.4.3) assigning the distributor category to a search result unit if the geographical spot is related to a distributor of a product;
(b.4.4) assigning the wholesale category to a search result unit if the geographical spot is related to a wholesaler of a product; and
(b.4.5) assigning the retail category to a search result unit if the geographical spot is related to a retailer of a product;

26. The system, as recited in claim 22, wherein the category provides five sub-categories for brand named products to provide classification for headquarter, branch office, distributor, wholesale and retail, wherein the steps (b.4) of the TMS method further comprises the steps of:
(b.4.1′) assigning the headquarter category to a search result unit if the geographical spot is related to a headquarter or a manufacturer of a product;
(b.4.2′) assigning the branch office category to a search result unit if the geographical spot is related to a branch office of a product;
(b.4.3′) assigning the distributor category to a search result unit if the geographical spot is related to a distributor of a product;
(b.4.4′) assigning the wholesale category to a search result unit if the geographical spot is related to a wholesaler of a product; and
(b.4.5′) assigning the retail category to a search result unit if the geographical spot is related to a retailer of a product.

27. The system, as recited in claim 22, wherein the category provides five sub-categories for brand named products to provide classification for headquarter, branch office, distributor, wholesale and retail; wherein the category provides five sub-categories for general products to provide classification for brand, manufacture, distributor, wholesale and retail; wherein the category provides three sub-categories for service to provide classification for headquarter, branch office and agent.

28. The system, as recited in claim 22, wherein when the search result unit is associated with a business information for a promotional offer, a prioritized category symbol is assigned to replace the category symbols of the subcategories such that the business entity is represented by the prioritized category symbol to visually display on the map.

29. The system, as recited in claim 25, wherein when the search result unit is associated with a business information for a promotional offer, a prioritized category symbol is assigned to replace the category symbols of the subcategories such that the business entity is represented by the prioritized category symbol to visually display on the map.

30. The system, as recited in claim 26, wherein when the search result unit is associated with a business information for a promotional offer, a prioritized category symbol is assigned to replace the category symbols of the subcategories such that the business entity is represented by the prioritized category symbol to visually display on the map.

31. The system, as recited in claim 27, wherein when the search result unit is associated with a business information for a promotional offer, a prioritized category symbol is assigned to replace the category symbols of the subcategories such that the business entity is represented by the prioritized category symbol to visually display on the map.

32. The system, as recited in claim 22, wherein said networking system is further arranged to provide a buyer search method for the members comprising the steps of:
(e.1) conducting a buyer search step if a buyer search request is received from the terminal through the network to obtain a buyer search result, wherein the buyer search request includes at least a keyword for a product or service and the buyer search result contains one or more search result units;
(e.2) translating the buyer search result to match a geographical location on a map to generate a geographical spot on the map, wherein one geographical spot is generated for one search result unit and each geographical spot represents one real address of a business entity;
(e.3) communicating with the terminal for visually displaying all the result units as geographical spots on the map, wherein a category is assigned for each search result unit, wherein a plurality of sub-categories is preset under the category for further classification of the search results units to related to one of the sub-categories, wherein a preset category symbol is used for each sub-category, wherein the category symbols for different sub-categories are different, thereby all the search result units as geographical spots on the map further provides the sub-category of each of the search result units on the map through the category symbol, wherein when the search result unit is associated with a business information for a promotional offer, a prioritized category symbol is assigned to replace the category symbols of the subcategories such that the business entity is represented by the prioritized category symbol to visually display on the map.

33. The system, as recited in claim 27, wherein said networking system is further arranged to provide a buyer search method for the members comprising the steps of:
(e.1) conducting a buyer search step if a buyer search request is received from the terminal through the network to obtain a buyer search result, wherein the buyer search request includes at least a keyword for a product or service and the buyer search result contains one or more search result units;
(e.2) translating the buyer search result to match a geographical location on a map to generate a geographical spot on the map, wherein one geographical spot is generated for one search result unit and each geographical spot represents one real address of a business entity; and
(e.3) communicating with the terminal for visually displaying all the result units as geographical spots on the map, wherein a preset category symbol is used for each sub-category, wherein the category symbols for different sub-categories are different, thereby all the search result units as geographical spots on the map further provides the sub-category of each of the search result units on the map through the category symbol, wherein when the search result unit is associated with a business information for a promotional offer, a prioritized category symbol is assigned to replace the category symbols of the subcategories such that the business entity is represented by the prioritized category symbol to visually display on the map.

34. The system, as recited in claim 33, wherein said networking system is further arranged to provide a seller search method comprising the steps of:
(f.1) generating a seller market place in response to a seller request of a business entity which is classified as a seller; and
(f.2) assigning a sub-category to the seller according to a seller category information of the seller request.

35. The system, as recited in claim 34, wherein when the search result unit corresponding to the business entity has a seller market place, the seller market place is linked the corresponding geographical spot representing the business entity on the map such that the seller market place is viewable through diverting from the corresponding geographical spot representing the business entity on the map.

36. The system, as recited in claim 34, wherein said networking system is further arranged to provide an auction method comprising the step of:
(g) posting an auction project in response to an auction request of an auction initiator for the auction project.

37. The system, as recited in claim 34, wherein said networking system is further arranged to provide an auction method comprising the step of:
(g′) posting a business promotion project for attracting and inviting investment, partners and buyers in response to an auction request for the business promotion project,
wherein the map is at a global level and is preset to divided into five continents, wherein each continent is preset to have one opening for headquarter branch office and one of the headquarter branch office is designated as a headquarter office, wherein a predetermined number of openings are assigned for the business promotion project on the map in response to the auction request.

38. The system, as recited in claim 37, wherein said networking system is further arranged to provide an advertisement method comprising the step of:
(h) providing an advertisement section which is viewable when a terminal is communicating with the system server, wherein the advertisement section is required to contain at least a real address of an advertiser; wherein the advertisement section is arranged for matching a geographical location on the map of the system to generate a geographical spot on the map which represents the real address of the advertiser such that the geographical spot of the advertiser is capable of being displayed on the map, wherein the geographical spot of the advertiser is further arranged for linking the contact information, the accessory information and the business information of the advertiser which represents a business entity to the corresponding geographical spot of the business entity on the map such that the contact information, the accessory information and the business information of the business entity is viewable through the corresponding geographical spot representing the business entity on the map.

39. The system, as recited in claim 38, wherein said networking system is further arranged to provide a community building method for information sharing and discussion comprising the step of:
(j) providing a community section which includes a news section interactively linked to a plurality of news source through the network for obtaining current news information from the news source which is viewable through the terminal communicating with the system server and a forum section adapted for receiving sharing information from the members which is then stored in the system database, viewable and searchable through the terminal communicating with the system server.
